(19) United States
(12) Patent Application Publication
(10) Pub. No.: US 2018/0003197 A1
(43) Pub. Date: Jan. 4, 2018

(54) ACCUMULATOR AND METHOD OF MAKING AND USING THE SAME

(71) Applicant: BorgWarner Inc., Auburn Hills, MI (US)

(72) Inventors: Brett PEGLOWSKI, Oakland, MI (US); Mitsuru ISHIHARA, Novi, MI (US)

(21) Appl. No.: 15/546,088

(22) PCT Filed: Jan. 13, 2016
(86) PCT No.: PCT/US2016/013135

§ 371 Date: Jul. 25, 2017

Related U.S. Application Data
(60) Provisional application No. 62/107,670, filed on Jan. 26, 2015.

(51) Int. Cl. F15B 1/24; F01M 1/10; F16H 61/00; F15B 1/033

(52) U.S. Cl. CPC F15B 1/24; F15B 1/033; F01M 1/10; F16H 61/0021; F01M 2001/1071; F16H 2061/0034

(57) ABSTRACT

A number of variations may include a fluid accumulator comprising, a housing and at least one movable piston wherein the piston separates an interior of the housing into a first chamber constructed and arranged for containing a first fluid, and a second chamber constructed and arranged for containing a second fluid, and wherein the first chamber has an first fluid opening and a first fluid exhaust constructed and arranged to expel excess first fluid from the fluid accumulator and prevent first fluid from entering the second chamber.

### CROSS-REFERENCE TO RELATED APPLICATIONS

This application claims the benefit of U.S. Provisional Application 62/107,670 filed Jan. 26, 2015.

### TECHNICAL FIELD

The field to which the disclosure generally relates to includes devices and components to store fluids.

### BACKGROUND

In some cases, accumulators may be used to temporarily or permanently store at least one fluid.

### SUMMARY OF ILLUSTRATIVE VARIATIONS OF THE INVENTION

A number of variations may include a product having a fluid accumulator comprising, a housing and at least one movable piston wherein the piston separates an interior of the housing into a first chamber constructed and arranged for containing a first fluid, and a second chamber constructed and arranged for containing a second fluid, and wherein the first chamber has an first fluid inlet and a first fluid exhaust constructed and arranged to expel excess first fluid from the fluid accumulator and prevent first fluid from entering the second chamber.

A number of variations may include a method including providing a fluid accumulator comprising, a housing and at least one movable piston wherein the piston separates an interior of the housing into a first chamber constructed and arranged for containing a first fluid, and a second chamber constructed and arranged for containing a second fluid, and wherein the first chamber has an inlet and an exhaust constructed and arranged to expel excess fluid wherein the first chamber; moving first fluid into the first chamber to displace the piston; and expelling excess first fluid through the exhaust when the pressure provided in the second chamber is exceeded by the pressure provided by the first fluid at a certain value.

Other illustrative variations of the invention will become apparent from the detailed description provided hereinafter. It should be understood that the detailed description and specific examples, while disclosing optional variations of the invention, are intended for purposes of illustration only and are not intended to limit the scope of the invention.

### BRIEF DESCRIPTION OF THE DRAWINGS

Select examples of variations of the invention will become more fully understood from the detailed description and the accompanying drawings, wherein:

FIG. 1 illustrates a product according to a number of variations.

FIG. 2 illustrates a product and method according to a number of variations.

FIG. 3 illustrates a product and method according to a number of variations.

FIG. 4 illustrates a product and method according to a number of variations.

FIG. 5 illustrates a method according to a number of variations.

FIG. 6 illustrates a method according to a number of variations.

### DETAILED DESCRIPTION OF ILLUSTRATIVE VARIATIONS OF THE INVENTION

The following description of the variations is merely illustrative in nature and is in no way intended to limit the invention, its application, or uses.

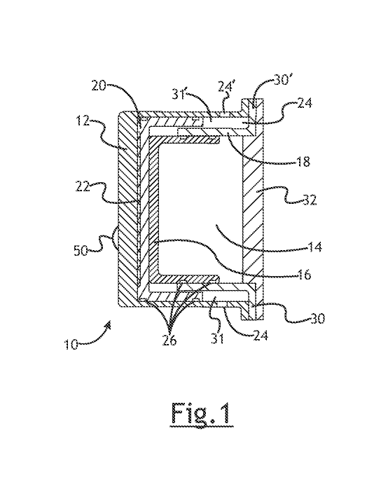

FIGS. 1-6 illustrate a number of variations. In a number of variations, a product 10 is shown. In a number of variations, the product 10 may include a accumulator (10). In a number of variations, the product 10 may include a fluid accumulator device for use in a vehicle 100 including, but not limited to, motor vehicles, space craft, watercraft, aircraft, or may be another type. In a number of variations, the vehicle 100 may be driven by an engine 60. In a number of variations, the engine 60 may be an internal combustion engine, an external combustion engine, an electric motor, a hybrid engine, or may be another type. In a number of variations, the engine 60 may include an engine head 62 and an engine block 64. In a number of variations, the vehicle 100 may have a transmission 70. In a number of variations, the transmission 70 may be automatic or manual or may be another type including, but not limited to, semi-automatic, diesel, non-synchronous, dual clutch, or may be another type. In a number of variations, the transmission 70 may be connected to the engine 60 in a vehicle power train 300. In a number of variations, a hydraulic system 200 may be connected to the vehicle powertrain 300 utilizing a fluid circuit 206 circulating a fluid constructed and arranged for cooling and lubrication of moving components of the vehicle powertrain 300. In a number of variations, the fluid may be oil, water, transmission fluid, air, or may be another type of fluid.

In a number of variations, the engine 60 may have an engine start and stop system 66 that may switch off the engine 60 during “travel interruptions” such as, but not limited to, being stuck at traffic lights, and may be controlled by an electronic control unit (ECU) 68 that switches off or on the engine 60 during the travel interruptions. The ECU 68 may automatically restart the engine 60 when given a “restart signal” based on predetermined conditions. In a number of variations where the transmission 70 is a manual transmission, the engine 60 may be switched off when the vehicle 100 stops moving and/or as soon as the transmission 70 may be shifted into a neutral or idle mode and certain conditions (engine oil temperature, outside temperature, etc.) are fulfilled. The engine 60 may be automatically restarted by stepping on a driver actuated clutch pedal. In a number of variations where the transmission 70 is an automatic transmission, the transmission 70 may have a variety of transmission shift elements 210 (clutches, brakes, etc.) actuated by an electrohydraulic system 200 according to a preset parameter or condition. In a number of variations, the condition for actuation may be that the fluid pressure in the engine 60 or transmission 70 is adequately high.

In a number of variations, the engine start and stop system 66 may be electronic and controlled by the ECU 68 which ascertains the conditions for starting and stopping the engine 60 and causes actuation of the engine 60. In a number of variations, the engine 60 and/or transmission 70 may be actuated in response to conditions within their various components with variables such as temperature, pressure, or may be another parameter. In a number of variations, the variables may be determined by sensors (72) located in and around various components within the engine 60 and/or transmission 70. In a number of variations, the engine start and stop system 66 may be controlled as a result of operator actuation. In a number of variations, operator actuation may include stepping on a gas or brake pedal.

In a number of variations, the transmission 70, engine 60, axle, or another vehicle 100 component may include or be part of a hydraulic system 200. In a number of variations, the hydraulic system 200 may be used to lubricate moving parts within the vehicle or to provide hydraulic pressure to operate the transmission 70, engine 60, axle (not shown) or another vehicle 100 component. In a number of variations, a first fluid (which may be oil, water, or may be another fluid) may be distributed throughout the hydraulic system 200 via a network of fluid passages forming the fluid circuit 206 while the engine 60 may be running. However, when the engine 60 is not running and/or has remained off for an extended period of time (as during stop in a start stop system 66), fluid may drain into a sump 250 wherein upon engine 60 restart, the fluid may take an appreciable amount of time to resume operation of the transmission 70, engine 60, axle (not shown) or another vehicle 100 component. In a number of variations, the hydraulic system 200 may include an electrohydraulic control unit (EHCU) 202, a fluid pump 204, a fluid circuit 206, and an accumulator 10. In a number of variations, the EHCU may be a part of/or be the same component as, the ECU 68. In a number of variations, using a start stop system of the vehicle 66, the accumulator 10 may be constructed and arranged to accumulate fluid when the engine 60 may be on and retain fluid when the engine 60 may be turned off, and to discharge fluid into the fluid circuit 206 when the engine 60 may be restarted. In a number of variations, an accumulator 10 may provide stored hydraulic pressure, or more particularly the stored hydraulic first fluid, to lubricate and/or operate the transmission 70, engine 60, axle (not shown) or another vehicle 100 component through release of fluid pressure. In a number of variations, the accumulator 10 may be controlled by the EHCU 202, or ECU 68 to accumulate or discharge the first fluid at different times based on conditions. These conditions may be determined by the sensors 72 throughout the hydraulic system 200 and may include temperature, fluid pressure, transmission actuation, engine actuation, or may be another condition.

Referring to FIG. 1, in a number of variations, the accumulator 10 may have a housing 12, a gas accumulator chamber 14, a gas accumulator cylinder 18, a gas accumulator piston 16, a hydraulic side piston 20, a hydraulic side chamber 22, an inlet 28 and/or an exhaust 24, a sleeve 30 and an end cap 32. In a number of variations the accumulator 10 may be formed from a metal or polymeric material. In a number of variations, the accumulator 10 may be cast or molded. In a number of variations, the sleeve 30 may be a part of or coupled with the housing 12. In a number of variations, the housing may have two sleeves 30, 30′ on both sides of the housing 12. In a number of variations, the end cap 32 may be a part of or coupled with the housing. In a number of variations, the sleeves 30, 30′, and end cap 32 may all be part of or coupled with the housing 12. In a number of variations, the housing 12 may define a gas accumulator chamber 14 and a hydraulic side chamber 22. In a number of variations, the hydraulic side chamber 22 (first chamber) may be used to house a first fluid. In a number of variations, the gas accumulator chamber (second chamber) 14 may be used to house a second fluid. In a number of variations, the housing 12 may have an opening 50 for the first fluid to enter and leave the accumulator 10 during operation of the accumulator 10. In a number of variations, the housing opening 50 enters the fluid into the hydraulic side chamber 22. In a number of variations, the housing 12 or end cap 32 may not have an opening. In a number of variations, the housing 12 may house at least one piston 16 that separates the first chamber 22 from the second chamber 14. In a number of variations, the piston 34 may include a gas accumulator piston 16 and/or a hydraulic side piston 20. In a number of variations, the gas accumulator piston 16 may be coupled to the hydraulic side piston 20. In a number of variations, the gas accumulator piston 16 and the hydraulic side piston 20 may move independently of one another. In a number of variations, the sleeves 30, 30′ and end cap 32 may be welded together. In a number of variations, the sleeves 30, 30′ and end cap 32 may be welded to the housing 12. In a number of variations, the first fluid may be oil, water, coolant, or transmission fluid. In a number of variations, the second fluid may be a non-compressible gas, air, oil, or water. In a number of variations, the gas accumulator chamber may include a bladder 1000 for housing the second fluid. In a number of variations, the bladder 1000 may be rubber or a polymeric material. In a number of variations, the piston may be attached to the housing 12 thorough at least one seal 26. In a number of variations, the seals may be o-ring, d-ring, or a-ring seals. In a number of variations, the hydraulic side piston 20 may have seals 26 with respect to the housing 12. In a number of variations, the gas accumulator piston 16 may have seals 26 with respect to the housing and/or sleeve 32. In a number of variations, the housing 12, hydraulic side piston 20 and sleeve 30 may define a exhaust passage 31 leading to an exhaust 24 that may be constructed and arranged to expel excess first fluid during operation of the accumulator 10 while also prevent first fluid from entering the second chamber or gas accumulator chamber 14. In a number of variations, the housing 12, hydraulic side piston 20 and sleeves 30, 30′ may define exhaust passages 31 on both sides of the housing 12, leading to a pair of exhausts 24, 24′ that may be constructed and arranged to expel excess first fluid during operation of the accumulator 10 while also prevent first fluid from entering the second chamber or gas accumulator chamber 14. In a number of variations, the accumulator exhaust 24 may be open to the atmosphere. In a number of variations, the accumulator exhaust 24 may connect to a sump 250 to collect the excess first fluid.

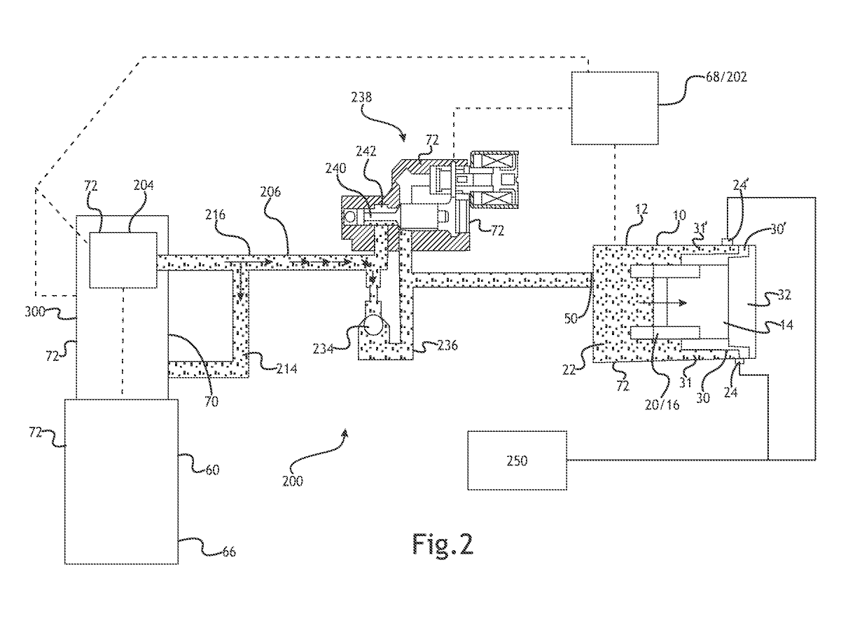

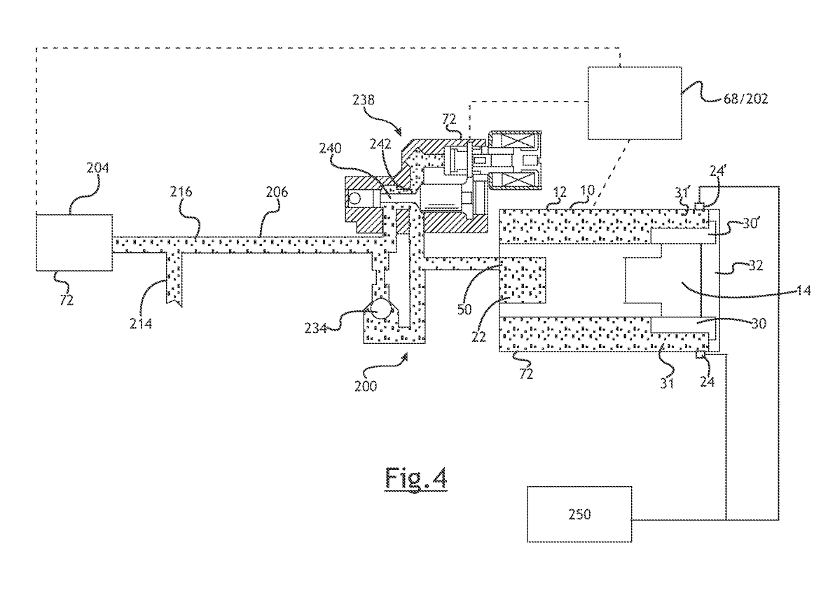

As shown in FIGS. 2-4, in a number of variations, the hydraulic system 200 may utilize a fluid pump 204 that may provide pressurized fluid via a fluid passage 214 to a transmission 70 to establish transmission line pressure and via fluid passage 216 to an accumulator 10. Fluid passages 214 and 216 may be formed by structures incorporating transmission of fluid and may be a tube. The fluid pump 204 may be operatively connected to the engine 60 and driven directly by the engine 60 or driven by another source. In a number of variations, the fluid pump 204 may be controlled by the EHCU 202 or ECU 68. In a number of variations, the fluid pump 204 may be driven directly by the engine 60 when it is on and idle when the engine 60 is off. In a number of variations, the accumulator 10 may have an internal piston (gas accumulator piston 16 and/or hydraulic side piston 20) with seals 26 to seal off the hydraulic side chamber 22 from the gas accumulator chamber 14. The gas accumulator chamber 14 may be used to counterbalance a force (shown in FIG. 2) due to the fluid line pressure of the first fluid, and provide gradual movement of the internal piston (gas accumulator piston 16 and/or hydraulic side piston 20) into the gas accumulator chamber 14 when the accumulator 10 may be accumulating first fluid into the hydraulic side chamber 22. In a number of variations, the gas accumulator chamber 14 may be utilized to provide internal piston (gas accumulator piston 16 and/or hydraulic side piston 20) return force (shown in FIG. 4) when the accumulator 10 may be being discharged.

Referring to FIG. 2, the fluid being channeled via passage 216 to a valve 234. The valve 234 may be utilized to achieve a passive accumulator 10 fill during transmission 70 operation, in particular when the fluid line pressure supplied by the pump 204 is greater than the pressure of the fluid already accumulated in a pressure cavity 238. In a number of variations, the accumulator 10 fill with a first fluid in the hydraulic system 200 may be termed “passive” due to the fact it takes place automatically, without any outside intervention or support, solely through the unseating of the valve 234. As understood by those skilled in the art, any appropriate mechanism may be utilized in place of the shown valve 234 to affect a passive accumulator fluid fill in the hydraulic system 200.

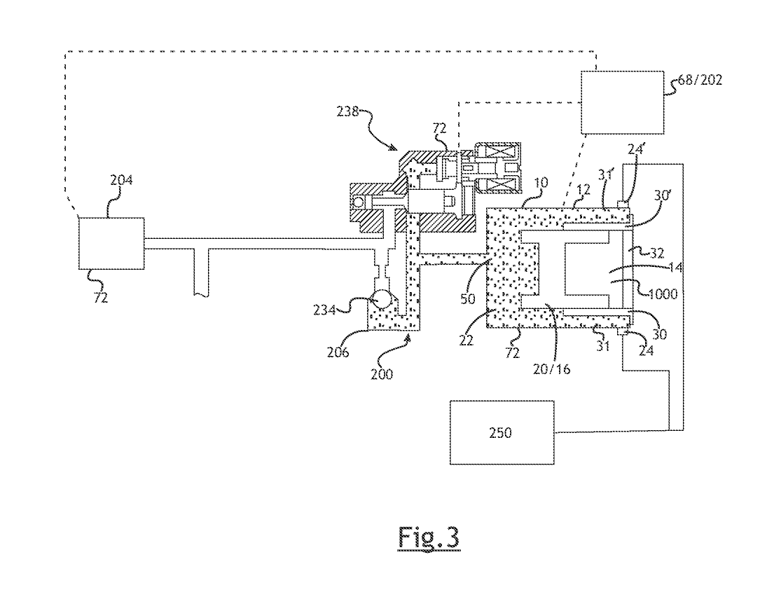

In a number of variations, when the vale 34 unseats under the pressure differential favoring the transmission line pressure, the first fluid from the passage 216 enters passage 236 for filling the accumulator 10. When the line pressure supplied by the pump 204 is not greater than the pressure of the fluid already accumulated in hydraulic side chamber 22, the valve 234 seats, thus restricting fluid flow to the accumulator 10 (shown in FIG. 3). In a number of variations, the line pressure supplied by the pump 204 is less than the fluid pressure inside the cavity 224 either when the pump 204 is off, i.e. when the engine 60 is not powering the pump 204, or when the pressure due to the gas accumulator cylinder 18 being compressed has risen to the point of being equal to or greater than the line pressure. In a number of variations, passage 236 connects the accumulator 10 with a solenoid 238. In a number of variations, the solenoid 238 may have a valve 240, which in FIGS. 2-4 is shown closed, i.e. restricting fluid from passage 236 from accessing cavity 242, and therefore from returning to passage 216.

In a number of variations the solenoid 238 may controlled via an algorithm programmed into the ECU 68 and/or ECHU 202. In a number of variations, the ECU 68 and/or ECHU 202 governs, i.e. actuates, the solenoid 238 to open the valve 240 and introduce first fluid from the accumulator 10 into passage 216, thereby feeding the fluid to various transmission components (not shown) via passage 214. In a number of variations, valve 240 may be generally directed to open following a prolonged engine 60 shut down, which typically leads to a first fluid drain into a 250 sump, and a subsequent engine 60 restart. In a number of variations, providing pressurized fluid to the transmission components from the accumulator 10 immediately after an engine 60 restart, thereby affords full transmission operation without an otherwise likely delay. In a number of variations, the first fluid may drain from the accumulator 10 into the sump 250 via the exhaust 24 when the pressure provided by the gas accumulator chamber 14 may be at a specific value. In a number of variations, the exhaust 24 may open based on a signal from the ECU 68 and/or ECHU 202 based on a preset condition within the pump 204, powertrain 700, accumulator 10 and/or hydraulic system 200 based on the conditions it is receiving from the sensors 72. In a number of variations, the first fluid may drain from the accumulator 10 into the sump 250 via the exhaust 24 when the fluid in line pressure provided by pump 204 may be two times greater than the pressure provided by the gas accumulator chamber 14. In a number of variations, the first fluid may drain from the accumulator 10 into the sump 250 via the exhaust 24 when the fluid in line pressure provided by pump 204 may be three times greater than the pressure provided by the gas accumulator chamber 14. In a number of variations, the first fluid may drain from the accumulator 10 into the sump 250 via the exhaust 24 when the fluid in line pressure provided by pump 204 may be five times greater than the pressure provided by the gas accumulator chamber 14. In a number of variations, the first fluid may drain from the accumulator 10 into the sump 250 via the exhaust 24 when the fluid in line pressure provided by pump 204 may be ten times greater than the pressure provided by the gas accumulator chamber 14. In a number of variations, the valves 234 and/or 240 may be ball valves, butterfly valves, ceramic disc valves, check valves, choke valves, diaphragm valves, gate valves, globe valves, knife valves, needle valves, pinch valves, piston valves, plug valves, poppet valves, spool valves, thermal expansion valves, pressure reducing valves, combinations thereof, or may be another type.

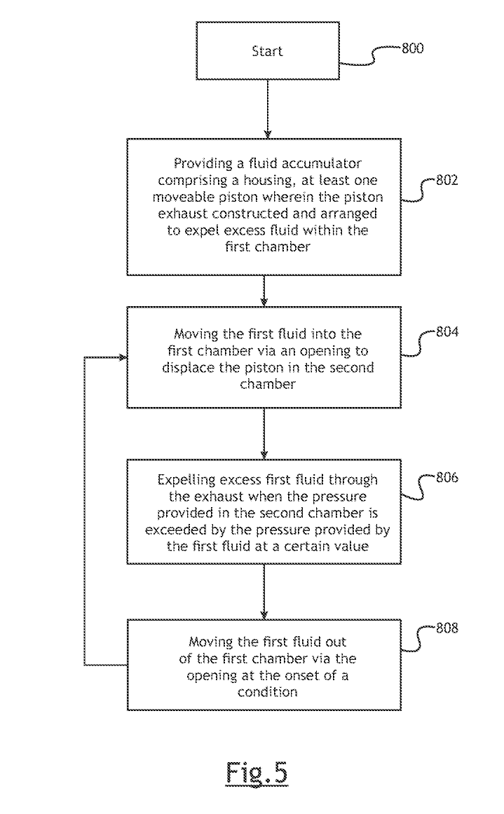

In a number of variations shown in FIG. 5, a method 800 is shown, in a number of variations the method includes in block 802 providing a fluid accumulator 10 comprising, a housing 12 comprising an opening 50 and at least one movable piston (16, 20) wherein the piston (16, 20) separates an interior of the housing 12 into a first chamber 22 constructed and arranged for containing a first fluid, and a second chamber 14 constructed and arranged for containing a second fluid, and wherein the first chamber 22 has an opening 50 and an exhaust 24 constructed and arranged to expel excess fluid wherein the first chamber. In a number of variations, method 800 further includes in block 804 moving the first fluid into the first chamber 22 via the opening to displace the piston (16, 20) into the second chamber 14. In a number of variations, the method 800 further includes block 806 representing expelling excess first fluid through the exhaust 24 when the pressure provided in the second chamber 14 is exceeded by the pressure provided by the first fluid at a certain value. In a number of variations, the method 800 further includes, as shown in block 808, moving the first fluid out of the first chamber 22 via the opening 50 at the onset of the condition. In a number of variations, accordingly, after block 886, the method returns to block 804 to again accumulate first fluid via the accumulator 10.

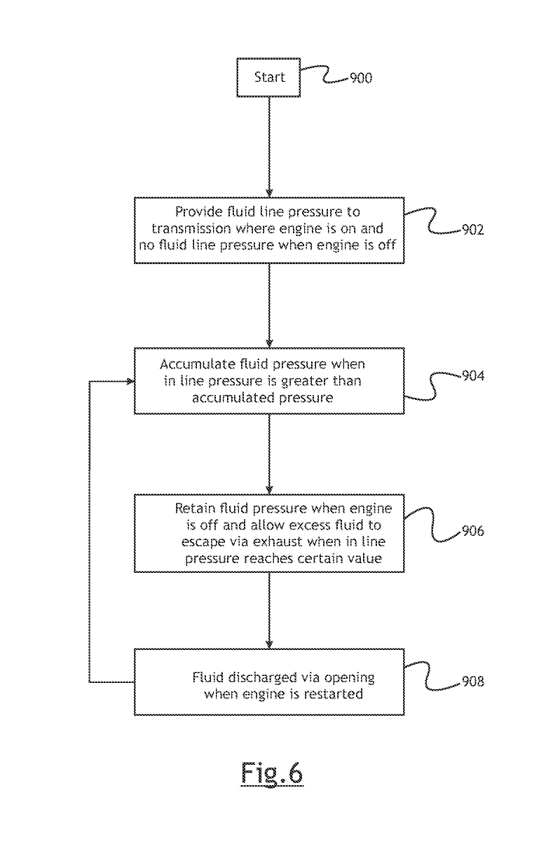

In a number of variations, a method 900 (shown in FIG. 6) for controlling a hydraulic system 200 of a vehicle powertrain 700 having an engine 60 and a transmission 70 may be provided and described with respect to the elements of the hydraulic control system 200 of FIGS. 1-4. The method commences in block 900. In a number of variations, in block 902 the method includes providing fluid line pressure to the transmission 70 when the engine is on, while no fluid pressure is provided when the engine 60 is off. The fluid pressure may be provided by the pump 204 via fluid passage 214. As described in relation to FIGS. 1-3, the pump 204 may be connected to the engine 60 for being operative when the engine 60 is on, and being inoperative, i.e. idle, when the engine 60 is off. In a number of variations, proceeding to block 904, according to the method the fluid is accumulated via the accumulator 10.

In a number of variations, as described in connection with FIGS. 1-4, the accumulator 10, being in fluid communication with passage 214 via the fluid passage 216, may be filled with a first fluid when the valve 234 becomes unseated due to the line pressure being greater than the pressure due to the fluid accumulated, i.e. contained, by the accumulator 10. In a number of variations, in block 906, when the line pressure is greater than a certain value, excess first fluid may escape the accumulator 10 through the exhaust 24. In block 906 in a number of variations, the fluid may be retained via the accumulator 10 when the engine 60 is turned off due to the solenoid 238 remaining closed. In a number of variations, in block 908 the fluid may be discharged via the opening 50 in the accumulator 10 to the fluid passage 216 when the engine 60 is restarted by opening the solenoid 238 via ECU 68 or EHCU 202. In a number of variations, subsequent to the engine 60 having been restarted, and the accumulator 10 having discharged its first fluid content to the transmission 70, the accumulator 10 may again be ready to accumulate first fluid to the level dictated by the gas accumulator cylinder 18. In a number of variations, accordingly, after block 910, the method returns to block 904 to again accumulate fluid via the accumulator 10.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include product comprising a fluid accumulator comprising, a housing and at least one movable piston wherein the piston separates an interior of the housing into a first chamber constructed and arranged for containing a first fluid, and a second chamber constructed and arranged for containing a second fluid, and wherein the first chamber has an first fluid inlet and a first fluid exhaust constructed and arranged to expel excess first fluid from the fluid accumulator and prevent first fluid from entering the second chamber.

Variation 2 may include a product as set forth in Variation 1 wherein the second chamber comprises a gas bladder constructed and arranged to contain the second fluid.

Variation 3 may include a product as set forth in any of Variations 1-2 wherein the fluid accumulator comprises a hydraulic side piston and a gas accumulator piston.

Variation 4 may include a product as set forth in any of Variations 1-3 wherein the fluid exhaust feeds into a sump.

Variation 5 may include a product as set forth in any of Variations 1-4 wherein the fluid accumulator further comprises seals.

Variation 6 may include a product as set forth in any of Variations 1-5 wherein the fluid accumulator is connected to a transmission fluid hydraulic system and wherein the first fluid is transmission fluid.

Variation 7 may include a product as set forth in any of Variations 1-6 wherein the fluid accumulator is connected to an engine oil fluid hydraulic system and wherein the first fluid is engine oil.

Variation 8 may include a product as set forth in Variations 1-7 wherein the fluid accumulator is connected to an axle oil fluid hydraulic system and wherein the first fluid is axle oil.

Variation 9 may include a product as set forth in any of Variations 2-8 wherein the exhaust is not accessible to the second fluid.

Variation 10 may include a product as set forth in any of Variations 1-9 wherein the exhaust is not accessible to the second chamber.

Variation 11 may include a method including providing a fluid accumulator comprising, a housing comprising an opening and at least one movable piston wherein the piston separates an interior of the housing into a first chamber constructed and arranged for containing a first fluid, and a second chamber constructed and arranged for containing a second fluid, and wherein the housing has an exhaust constructed and arranged to expel excess fluid wherein the first chamber; moving first fluid into the first chamber to displace the piston; and expelling excess first fluid through the exhaust when the pressure provided in the second chamber is exceeded by the pressure provided by the first fluid at a certain value.

Variation 12 may include a method as set forth in Variation 11 wherein the second chamber comprises a gas bladder constructed and arranged to contain the second fluid.

Variation 13 may include a method as set forth in any of Variations 11-12 wherein the fluid accumulator comprises a hydraulic side piston and a gas accumulator piston.

Variation 14 may include a method as set forth in any of Variations 11-13 wherein the exhaust feeds into a sump.

Variation 15 may include a method as set forth in any of Variations 11-14 wherein the fluid accumulator further comprises seals.

Variation 16 may include a method as set forth in any of Variations 11-15 wherein the fluid accumulator is connected to a transmission fluid hydraulic system and wherein the first fluid is transmission fluid.

Variation 17 may include a method as set forth in any of Variations 11-16 wherein the fluid accumulator is connected to an engine oil fluid hydraulic system and wherein the first fluid is engine oil.

Variation 18 may include a method as set forth in any of Variations 11-17 wherein the fluid accumulator is connected to an axle oil fluid hydraulic system and wherein the first fluid is axle oil.

Variation 19 may include a method as set forth in any of Variations 12-18 wherein the exhaust is not accessible to the second fluid.

Variation 20 may include a method as set forth in any of Variations 11-19 wherein the exhaust is not accessible to the second chamber.

Variation 21 may include a method, and/or a product as set forth in any of Variations 1-20 wherein the product is a part of a hydraulic system.

Variation 22 may include a method, and/or a product as set forth in any of Variation 21 wherein the hydraulic system comprises a vehicle powertrain comprising an engine and a transmission.

Variation 23 may include a method, and/or a product as set forth in any of Variations 1-22 wherein the engine has a start/stop system.

Variation 24 may include a method, and/or a product as set forth in any of Variations 1-23 wherein the accumulator is controlled by an electrohydraulic control unit and/or electronic control unit and operates based on certain conditions within the hydraulic system.

Variation 25 may include a method, and/or a product as set forth in any of Variations 24 wherein the conditions are determined by sensors throughout the hydraulic system and include temperature, fluid pressure, transmission actuation, or engine actuation.

Variation 26 may include a method, and/or a product as set forth in any of Variations 1-25 wherein the accumulator is cast or molded.

Variation 26 may include a method, and/or a product as set forth in any of Variations 1-25 wherein the housing comprises two sleeves and an end cap.

Variation 27 may include a method, and/or a product as set forth in any of Variations 1-26 wherein the housing has an opening for the first fluid to enter and leave the accumulator.

Variation 28 may include a method, and/or a product as set forth in any of Variations 1-27 wherein the gas accumulator piston is coupled to the hydraulic side piston.

Variation 29 may include a method, and/or a product as set forth in any of Variations 1-28 wherein the gas accumulator piston and hydraulic side piston move independently of one another.

Variation 30 may include a method, and/or a product as set forth in any of Variations 1-29 wherein sleeves and end cap are welded to the housing.

Variation 31 may include a method, and/or a product as set forth in any of Variations 1-30 wherein the second fluid is gas, air, oil, or water.

Variation 32 may include a method, and/or a product as set forth in any of Variations 1-31 wherein the gas accumulator chamber comprises a bladder for housing the second fluid comprising a rubber or polymeric material.

Variation 33 may include a method, and/or a product as set forth in any of Variations 1-32 wherein the seals are o-ring, d-ring, or a-ring seals.

Variation 34 may include a method, and/or a product as set forth in any of Variations 1-33 wherein the exhaust feed excess first fluid into a sump.

Variation 35 may include a method for controlling a hydraulic system of a vehicle powertrain comprising an engine and a transmission wherein fluid line pressure is provided from the engine to the transmission when the engine is on and no fluid pressure is provided when the engine is off and wherein fluid pressure may be provided by a pump to a fluid passage wherein the pump is operative when the engine is on and inoperative when the engine is off.

Variation 36 may include a method as set forth in Variation 35 further including wherein fluid is accumulated in the accumulator when the engine is off.

Variation 37 may include a method as set forth in any of Variations 35-36 further including the accumulator moving fluid into an exhaust when the line pressure exceeds a certain value.

Variation 38 may include a method as set forth in any of Variations 35-37 wherein the fluid is discharged through the opening when the engine is restarted.

Variation 39 may include a product method as set forth in any of Variations 1-37 wherein the exhaust opens based on a signal from the ECU and/or ECHU based on a preset condition within the pump, powertrain, accumulator and/or hydraulic system based on the conditions it is receiving from the sensors.

The above description of select examples of the invention is merely exemplary in nature and, thus, variations or variants thereof are not to be regarded as a departure from the spirit and scope of the invention.

What is claimed is:

1. A product comprising: a fluid accumulator comprising, a housing and at least one movable piston wherein the piston separates an interior of the housing into a first chamber constructed and arranged for containing a first fluid, and a second chamber constructed and arranged for containing a second fluid, and wherein the first chamber has a first fluid opening and a first fluid exhaust constructed and arranged to expel excess first fluid from the fluid accumulator and prevent first fluid from entering the second chamber.

2. A product as set forth in claim 1 wherein the second chamber comprises a gas bladder constructed and arranged to contain the second fluid.

3. A product as set forth in claim 1 wherein the fluid accumulator comprises a hydraulic side piston and a gas accumulator piston.

4. A product as set forth in claim 1 wherein the fluid exhaust feeds into a sump.

5. A product as set forth in claim 1 wherein the fluid accumulator further comprises seals.

6. A product as set forth in claim 1 wherein the fluid accumulator is connected to a transmission fluid hydraulic system and wherein the first fluid is transmission fluid.

7. A product as set forth in claim 1 wherein the fluid accumulator is connected to an engine oil fluid hydraulic system and wherein the first fluid is engine oil.

8. A product as set forth in claim 1 wherein the fluid accumulator is connected to an axle oil fluid hydraulic system and wherein the first fluid is axle oil.

9. A product as set forth in claim 1 wherein the exhaust is not accessible to the second fluid.

10. A product as set forth in claim 1 wherein the exhaust is not accessible to the second chamber.

11. A method comprising: providing a fluid accumulator comprising, a housing comprising an opening and at least one movable piston wherein the piston separates an interior of the housing into a first chamber constructed and arranged for containing a first fluid, and a second chamber constructed and arranged for containing a second fluid, and wherein the first chamber has an opening and an exhaust constructed and arranged to expel excess fluid wherein the first chamber;
moving first fluid into the first chamber to displace the piston; and
expelling excess first fluid through the exhaust when the pressure provided in the second chamber is exceeded by the pressure provided by the first fluid at a certain value.

12. A method as set forth in claim 11 wherein the second chamber comprises a gas bladder constructed and arranged to contain the second fluid.

13. A method as set forth in claim 11 wherein the fluid accumulator comprises a hydraulic side piston and a gas accumulator piston.

14. A method as set forth in claim 11 wherein the exhaust feeds into a sump.

15. A method as set forth in claim 11 wherein the fluid accumulator further comprises seals.

16. A method as set forth in claim 11 wherein the fluid accumulator is connected to a transmission fluid hydraulic system and wherein the first fluid is transmission fluid.

17. A method as set forth in claim 11 wherein the fluid accumulator is connected to an engine oil fluid hydraulic system and wherein the first fluid is engine oil.

18. A method as set forth in claim 11 wherein the fluid accumulator is connected to an axle oil fluid hydraulic system and wherein the first fluid is axle oil.

19. A method as set forth in claim 11 wherein the exhaust is not accessible to the second fluid.

20. A method as set forth in claim 11 wherein the exhaust is not accessible to the second chamber.
